(19) United States
(12) Patent Application Publication
(10) Pub. No.: US 2025/0003752 A1
(43) Pub. Date: Jan. 2, 2025

(54) OBSTACLE DETECTION APPARATUS, OBSTACLE DETECTION METHOD, AND NON-TRANSITORY COMPUTER-READABLE MEDIUM

(71) Applicant: NEC Corporation, Minato-ku, Tokyo (JP)

(72) Inventors: Akira TSUJI, Tokyo (JP); Eiki Ishidera, Tokyo (JP)

(73) Assignee: NEC Corporation, Minato-ku, Tokyo (JP)

(21) Appl. No.: 18/710,239

(22) PCT Filed: Nov. 29, 2021
(86) PCT No.: PCT/JP2021/043662

§ 371 Date: May 15, 2024

(51) Int. Cl. G01C 21/00

(52) U.S. Cl. CPC G01C 21/005

(57) ABSTRACT

An obstacle detection apparatus acquires a three-dimensional map representing a three-dimensional position of each of a plurality of points of a facility and position information representing a position of a user. The obstacle detection apparatus determines a detection range as a detection target for an obstacle region from a region around the position of the user on the three-dimensional map by using the three-dimensional map and the position information. The obstacle detection apparatus detects the obstacle region from the detection range.

### TECHNICAL FIELD

The present disclosure relates to a technology for detecting an obstacle.

### BACKGROUND ART

A technology for detecting an obstacle by using a sensor has been developed. For example, Patent Literature 1 discloses a technology in which a self-propelled traveling device is moved in a residence to find an obstacle to walking in the residence, thereby allowing an administrator or the like to grasp each obstacle to walking in the residence. As a result, the administrator or the like can improve arrangement of furniture or the like in the residence.

### CITATION LIST

### Patent Literature

Patent Literature 1: Japanese Unexamined Patent Application Publication No. 2016-192040

### SUMMARY OF INVENTION

### Technical Problem

In the invention of Patent Literature 1, it is assumed that an administrator or the like browses information regarding an obstacle to walking after the obstacle to walking in a residence is found. The present invention has been made in view of such a problem, and an object of the present invention is to provide a new technology for detecting an obstacle.

### Solution to Problem

An obstacle detection apparatus of the present disclosure includes an acquisition unit configured to acquire a three-dimensional map representing a three-dimensional position of each of a plurality of points of a facility and position information representing a position of a user, a detection range determination unit configured to determine a detection range as a detection target for an obstacle region from a region around the position of the user on the three-dimensional map by using the three-dimensional map and the position information, and a detection unit configured to detect the obstacle region from the detection range.

An obstacle detection method of the present disclosure is executed by a computer. The obstacle detection method includes an acquisition step of acquiring a three-dimensional map representing a three-dimensional position of each of a plurality of points of a facility and position information representing a position of a user, a detection range determination step of determining a detection range as a detection target for an obstacle region from a region around the position of the user on the three-dimensional map by using the three-dimensional map and the position information, and a detection step of detecting the obstacle region from the detection range.

A computer-readable medium of the present disclosure stores a program causing a computer to execute the obstacle detection method of the present disclosure.

### Advantageous Effects of Invention

According to the present disclosure, a new technology for detecting an obstacle is provided.

### BRIEF DESCRIPTION OF DRAWINGS

FIG. 1 is a diagram illustrating an overview of an operation of an obstacle detection apparatus of a first example embodiment.

FIG. 2 is a block diagram illustrating a functional configuration of the obstacle detection apparatus of the first example embodiment.

FIG. 3 is a block diagram illustrating a hardware configuration of a computer that implements the obstacle detection apparatus.

FIG. 4 is a flowchart illustrating a flow of processing executed by the obstacle detection apparatus of the first example embodiment.

FIG. 5 is a first diagram illustrating a detection range.

FIG. 6 is a second diagram illustrating a detection range.

FIG. 7 is a third diagram illustrating a detection range.

FIG. 8 is a block diagram illustrating a functional configuration of the obstacle detection apparatus including an output unit.

FIG. 9 is a first diagram illustrating output information.

FIG. 10 is a second diagram illustrating output information.

### EXAMPLE EMBODIMENT

Hereinafter, an example embodiment of the present disclosure is described in detail with reference to the drawings. In the drawings, the same or corresponding elements are denoted by the same reference numerals, and repeated description is omitted as necessary for clarity of description. In addition, unless otherwise described, predetermined values such as predetermined values and thresholds are stored in advance in a storage device or the like accessible from a device using the values. Furthermore, unless otherwise described, a storage unit includes one or more storage devices of any number.

### First Example Embodiment

### <Overview>

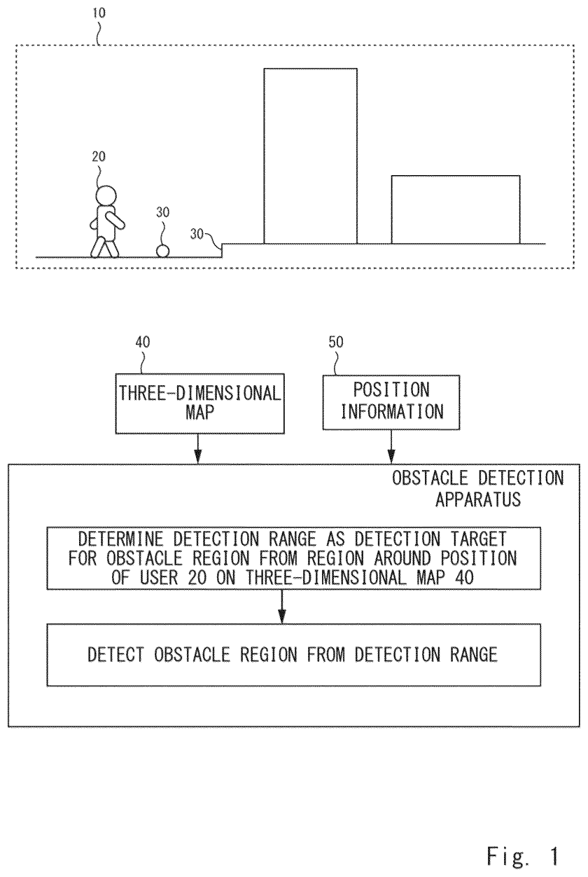

FIG. 1 is a diagram illustrating an overview of an operation of an obstacle detection apparatus 2000 of a first example embodiment. Here, FIG. 1 is a diagram for facilitating understanding of the overview of the obstacle detection apparatus 2000, and the operation of the obstacle detection apparatus 2000 is not limited to that illustrated in FIG. 1.

The obstacle detection apparatus 2000 detects an obstacle 30 that hinders movement of a user 20 in a situation where the user 20 moves in a facility 10. The facility 10 may be an outdoor facility or an indoor facility. The outdoor facility 10 is, for example, a substation. The indoor facility 10 is, for example, the inside of a factory. The user 20 is a person who uses the obstacle detection apparatus 2000 in the facility 10, and is, for example, a worker who performs work in the facility 10.

The obstacle detection apparatus 2000 detects the obstacle 30 by using a three-dimensional map 40 that is data representing a three-dimensional map of the facility 10. The three-dimensional map 40 represents a three-dimensional position (three-dimensional coordinates) of each of a plurality of points of the facility 10. The three-dimensional map 40 is implemented by, for example, point cloud data representing three-dimensional positions of the plurality of points of the facility 10. The point cloud data includes point data for each of the plurality of points. The point data indicates three-dimensional coordinates of a corresponding point. The point cloud data is obtained, for example, by scanning the plurality of points of the facility 10 using a light detection and ranging (LiDAR), a depth camera, or the like. However, as described below, the three-dimensional map 40 is not limited to the point cloud data.

The obstacle detection apparatus 2000 further acquires position information 50 indicating the position of the user 20. For example, the position information 50 indicates the position of a terminal possessed by the user 20 (hereinafter, referred to as a user terminal). The user terminal is, for example, a smartphone, a tablet terminal, a wearable terminal (an eyeglass-type terminal, a watch-type terminal, or the like), or the like. However, the position indicated by the position information 50 is not limited to the position of the user terminal as described below.

The obstacle detection apparatus 2000 detects an obstacle region, which is a three-dimensional region representing the obstacle 30, from a predetermined range around the user 20 on the three-dimensional map 40 (hereinafter, referred to as a detection range). Therefore, the obstacle detection apparatus 2000 determines the detection range based on the position of the user 20 indicated by the position information 50. Then, the obstacle detection apparatus 2000 detects the obstacle region from the determined detection range.

### Example of Advantageous Effect

In a facility such as a substation or a factory, it is not preferable that a worker or the like is injured by stumbling over an obstacle, hitting an obstacle, or the like. For example, the number of such injuries can also be treated as an evaluation index of a company regarding job safety. In addition, human resources are reduced in a case where the worker cannot work for a while due to an injury. Therefore, it is important to prevent occurrence of an injury due to an obstacle.

Therefore, the obstacle detection apparatus 2000 detects the obstacle region present in the detection range around the user 20 (such as the worker who performs work in the facility 10) by using the three-dimensional map 40 and the position information 50. In this way, the user 20 can easily grasp the obstacle 30 present around the user oneself. Therefore, it is possible to prevent an injury caused by the obstacle 30 in the facility 10.

Here, as one of methods for preventing occurrence of an injury caused by the obstacle 30, a method of previously finding the obstacle 30 present in the facility 10 and providing the information to the user 20 may be considered. However, it is a heavy burden on the user 20 to grasp the positions of all the obstacles 30 in advance and move in the facility 10 while being conscious of the presence of the obstacles 30. In addition, there is a risk that the user 20 who has forgotten the presence of the obstacle 30 may be injured by the obstacle 30.

In this regard, the obstacle detection apparatus 2000 automatically detects the obstacle 30 around the user 20, and thus, the user 20 does not need to grasp the position of the obstacle 30 in advance. Therefore, a burden on the user 20 is smaller as compared with a case where the user 20 needs to grasp the positions of all the obstacles 30 in advance. In addition, it is also possible to prevent occurrence of a problem that the user 20 who has forgotten the presence of the obstacle 30 is injured by the obstacle 30.

Hereinafter, the obstacle detection apparatus 2000 of the present example embodiment is described in more detail.

### <Example of Functional Configuration>

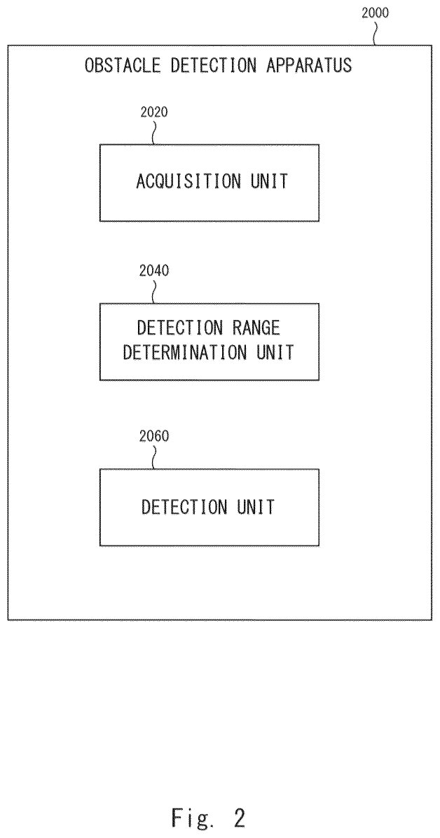

FIG. 2 is a block diagram illustrating a functional configuration of the obstacle detection apparatus 2000 of the first example embodiment. The obstacle detection apparatus 2000 includes an acquisition unit 2020, a detection range determination unit 2040, and a detection unit 2060. The acquisition unit 2020 acquires the three-dimensional map 40 and the position information 50. The detection range determination unit 2040 determines the detection range as a detection target for the obstacle region from a region around the position of the user 20 on the three-dimensional map 40. The detection unit 2060 detects the obstacle region from the detection range.

### <Example of Hardware Configuration>

Each functional configuration unit of the obstacle detection apparatus 2000 may be implemented by hardware that implements each functional configuration unit (for example, a hard-wired electronic circuit) or may be implemented by a combination of hardware and software (for example, a combination of an electronic circuit and a program that controls the electronic circuit or the like). Hereinafter, a case where each functional configuration unit of the obstacle detection apparatus 2000 is implemented by a combination of hardware and software is further described.

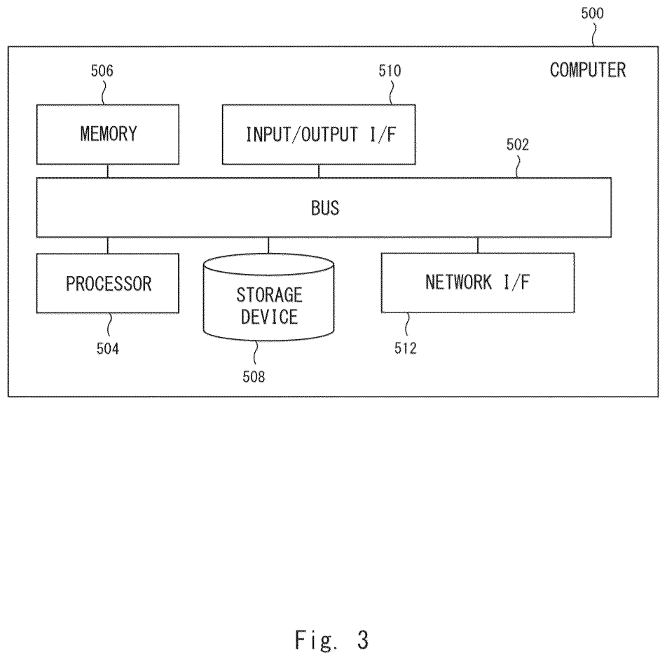

FIG. 3 is a block diagram illustrating a hardware configuration of a computer 500 that implements the obstacle detection apparatus 2000. The computer 500 is any computer. For example, the computer 500 is a stationary computer such as a personal computer (PC) or a server machine. In addition, for example, the computer 500 is a portable computer such as a smartphone or a tablet terminal. The portable computer is, for example, a user terminal possessed by the user 20. The computer 500 may be a dedicated computer designed to implement the obstacle detection apparatus 2000 or may be a general-purpose computer.

For example, by installing a predetermined application in the computer 500, each function of the obstacle detection apparatus 2000 is implemented by the computer 500. The above-described application is configured with a program for implementing the functional configuration units of the obstacle detection apparatus 2000. Note that a method of acquiring the program is arbitrary. For example, the program can be acquired from a storage medium (a DVD disk, a USB memory, or the like) in which the program is stored. In addition, for example, the program can be acquired by downloading the program from a server device that manages a storage device in which the program is stored.

The computer 500 includes a bus 502, a processor 504, a memory 506, a storage device 508, an input/output interface 510, and a network interface 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is various processors such as a central processing unit (CPU), a graphics processing unit (GPU), or a field-programmable gate array (FPGA). The memory 506 is a main storage device implemented by using a random access memory (RAM) or the like. The storage device 508 is an auxiliary storage device implemented by using a hard disk, a solid state drive (SSD), a memory card, a read only memory (ROM), or the like.

The input/output interface 510 is an interface for connecting the computer 500 and an input/output device. For example, an input device such as a keyboard and an output device such as a display device are connected to the input/output interface 510.

The network interface 512 is an interface for connecting the computer 500 to a network. The network may be a local area network (LAN) or a wide area network (WAN).

The storage device 508 stores a program for implementing each functional configuration unit of the obstacle detection apparatus 2000 (a program for implementing the above-described application). The processor 504 reads the program to the memory 506 and executes the program to implement each functional configuration unit of the obstacle detection apparatus 2000.

The obstacle detection apparatus 2000 may be implemented by one computer 500 or may be implemented by the plurality of computers 500. In the latter case, the configurations of the computers 500 do not need to be the same, and can be different from each other. For example, some of the functions of the obstacle detection apparatus 2000 may be implemented by a user terminal, and the other functions may be implemented by a server device.

### <Flow of Processes>

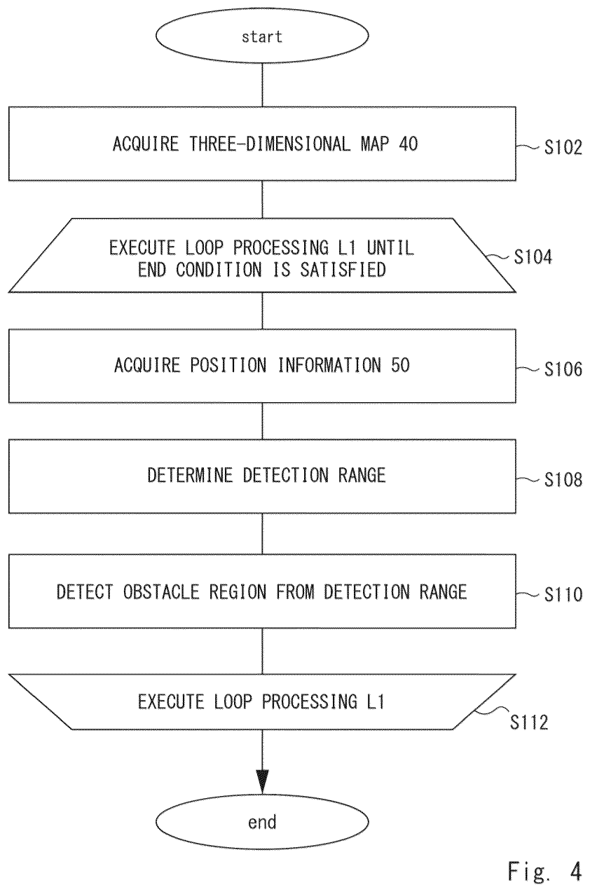

FIG. 4 is a flowchart illustrating a flow of processes by the obstacle detection apparatus 2000 of the first example embodiment. The flow of processes illustrated in FIG. 4 is an example, and the flow of processes executed by the obstacle detection apparatus 2000 is not limited to the flow illustrated in FIG. 4.

The acquisition unit 2020 acquires the three-dimensional map 40 (S102). S104 to S112 constitute loop processing L1. The loop processing L1 is repeatedly executed until a predetermined end condition is satisfied.

In S104, the obstacle detection apparatus 2000 determines whether or not the end condition is satisfied. In a case where the end condition is satisfied, the processing of FIG. 4 ends. On the other hand, in a case where the end condition is not satisfied, next, S106 is executed.

The acquisition unit 2020 acquires the position information 50 (S106). The detection range determination unit 2040 determines the detection range by using the three-dimensional map 40 and the position information 50 (S108). The detection unit 2060 detects the obstacle region from the detection range (S110). Since S112 is the end of the loop processing L1, S104 is executed next.

As described above, by repeatedly acquiring the position information 50 and detecting the obstacle region, it is possible to grasp whether or not the obstacle 30 is present around the user 20 after the movement according to the movement of the user 20.

Here, various conditions can be adopted as the end condition of the loop processing L1. For example, the end condition is a condition that “a predetermined input operation is performed”. Alternatively, for example, the end condition is a condition that “the user 20 goes out of a range shown on the three-dimensional map 40”. For example, in a case where the three-dimensional map 40 represents the entire facility 10, the end condition is satisfied when the user 20 goes out of the facility 10.

### <Three-Dimensional Map 40>

The three-dimensional map 40 is generated by measuring the three-dimensional position of each of the plurality of points of the facility 10 using various sensors. The sensor used for generating the three-dimensional map 40 is, for example, a distance measurement apparatus capable of measuring a distance between the sensor and a measurement target. The distance measurement apparatus measures a three-dimensional position of each of a plurality of points in a real space using, for example, electromagnetic waves such as laser light. Specifically, the distance measurement apparatus emits electromagnetic waves in a plurality of different directions and receives reflected waves which are the electromagnetic waves reflected by an object for respective electromagnetic waves. Then, the distance measurement apparatus generates point data representing a three-dimensional position of a point where the electromagnetic waves are reflected from a relationship between the emitted electromagnetic waves and the reflected waves thereof. Point cloud data is generated as a set of point data obtained for each of the plurality of points of the facility 10. Examples of such a distance measurement apparatus include a LiDAR and a depth camera.

The sensor is not limited to the distance measurement apparatus. For example, a camera that generates a two-dimensional captured image may be used as the sensor. In this case, for example, by applying structure from motion (SFM) to a plurality of captured images including the facility 10, the three-dimensional coordinates of each of the plurality of points of the facility 10 are determined, and the three-dimensional map 40 including a set of point data indicating the three-dimensional coordinates is generated. In this case, the plurality of captured images are obtained by capturing the facility 10 from different directions. An existing technology can be used as a technology for generating three-dimensional data of a captured object using the SFM.

The three-dimensional map 40 only needs to include data (point data) indicating the three-dimensional position of each of the plurality of points of the facility 10, and is not limited to the point cloud data described above. Examples of the three-dimensional data other than the point cloud data include mesh data and surface data.

The sensor may be used in a state of being fixed at a specific position, or may be used while moving. In the former case, for example, measurement is performed using the sensor fixed using a tripod or the like. In addition, for example, the worker may stay at a specific position in a state of holding or wearing the sensor, and perform measurement by using the sensor. Thereafter, in a case where it is desired to perform measurement at another position, the same operation is performed at the another position. As a result, measurement can be performed at each of the plurality of points of the facility 10.

In a case where the sensor is used while moving, for example, the worker moves in a state of holding or wearing the sensor in the facility 10 to measure the facility 10. In this case, the sensor is provided in a smartphone held by the worker, a wearable device worn by the worker, or the like. In addition, for example, the measurement of the facility 10 may be performed by causing a moving object (for example, a flying or traveling robot), to which the sensor is attached, to move in the facility 10. By causing the sensor to repeatedly perform the measurement in such a moving state, the measurement can be performed at each of the plurality of locations in the facility 10.

A plurality of measurements may be performed not only by changing the position of the sensor but also by changing the measurement direction at the same position.

In a case where the measurement is performed at a plurality of positions or from measurement directions, the three-dimensional map 40 is generated by integrating measurement results obtained by the respective measurements. An existing technology can be used as a technology for integrating measurement results obtained at a plurality of positions or from measurement directions to generate one piece of three-dimensional data.

Here, the three-dimensional map 40 may be data representing the measurement result of the distance measurement apparatus or the result of the SFM as it is, or may be data obtained by performing predetermined processing on these pieces of data. Examples of the predetermined processing include processing of applying coordinate transformation to each point data in such a way that the position of a specific point in a real space becomes the origin of the coordinate space of the three-dimensional map 40 or downsampling processing of omitting point data at predetermined distance intervals to achieve size reduction.

Here, in the flowchart of FIG. 4, the obstacle detection apparatus 2000 continues to use the three-dimensional map 40 acquired in S102 as it is. However, after acquiring the three-dimensional map 40, the obstacle detection apparatus 2000 may repeatedly update the three-dimensional map 40 based on a result of measurement performed in real time (a timing when the obstacle detection apparatus 2000 is used). In this case, for example, the measurement is performed using the sensor provided in the user terminal.

The obstacle detection apparatus 2000 detects three-dimensional data not included in the three-dimensional map 40 by comparing the three-dimensional data obtained by the measurement performed in real time with the three-dimensional map 40. For example, three-dimensional data representing an object temporarily placed in the facility 10 or an object newly installed in the facility 10 after the three-dimensional map 40 is generated is detected as the three-dimensional data not included in the three-dimensional map 40. Therefore, the obstacle detection apparatus 2000 updates the three-dimensional map 40 in such a way as to include the three-dimensional data detected in this manner.

### <Acquisition of Three-Dimensional Map 40: S102>

The acquisition unit 2020 acquires the three-dimensional map 40 (S102). There are various methods for the acquisition unit 2020 to acquire the three-dimensional map 40. For example, the three-dimensional map 40 is stored in advance in a storage unit accessible from the obstacle detection apparatus 2000. The acquisition unit 2020 acquires the three-dimensional map 40 by accessing the storage unit.

In addition, for example, the three-dimensional map 40 may be input to the obstacle detection apparatus 2000 in response to a user operation. For example, the user connects a portable storage unit (such as a memory card) in which the three-dimensional map 40 is stored to the obstacle detection apparatus 2000, and inputs the three-dimensional map 40 from the storage unit to the obstacle detection apparatus 2000.

Alternatively, for example, the acquisition unit 2020 may acquire the three-dimensional map 40 by receiving the three-dimensional map 40 transmitted from another apparatus. For example, the another apparatus is an apparatus that generates the three-dimensional map 40.

### <Position Information 50>

The position information 50 is information indicating the position of the user 20. Here, various information can be adopted as the information indicating the position of the user 20. For example, the position information 50 indicates the position of the user terminal of the user 20. Here, various existing technologies can be used as a technology for determining the position of a specific terminal in a specific place (here, in the facility 10). For example, the position of the user terminal can be determined by detecting the position of a position sensor such as a global positioning system (GPS) sensor provided in the user terminal. In addition, for example, the position of the user terminal may be determined based on communication between a beacon or an RFID sensor provided in the facility 10 and the user terminal.

In addition, for example, the position of the user terminal may be determined using measurement data obtained from a sensor provided in the user terminal. The measurement data used to determine the position of the user terminal is, for example, a two-dimensional captured image obtained from a two-dimensional camera or three-dimensional data obtained from a depth camera, a LiDAR, or the like. An existing technology can be used as a technology for determining a position where the measurement is performed from these pieces of measurement data.

In a case where a captured image is used as the measurement data, for example, a captured image obtained by capturing at a corresponding position from a corresponding capturing direction is prepared in advance as a reference image for each of various combinations of the position and the capturing direction of the facility 10. Then, a position corresponding to the reference image matching the captured image obtained from the user terminal can be determined as the position of the user 20 by determining a reference image that matches the captured image among the reference images.

In a case where three-dimensional data is used as the measurement data, for example, three-dimensional data matching the three-dimensional data obtained from the user terminal is detected from the three-dimensional map 40. The three-dimensional data detected in this manner represents the three-dimensional region measured by the sensor. In addition, the measurement direction can be determined based on the measurement data. Then, the position of the sensor (that is, the position of the user terminal) can be determined based on the measured three-dimensional region and the measurement direction.

In addition, for example, a function of self-position estimation adopted in an autonomous mobile robot may be provided in the user terminal, and the position of the user terminal may be determined by the self-position estimation.

The user terminal does not have to be used to determine the position of the user 20. For example, the position of the user 20 may be determined by detecting the user 20 using a monitoring sensor (a camera or the like) provided in the facility 10.

The generation of the position information 50 may be performed by the obstacle detection apparatus 2000 or may be performed by an apparatus (such as a user terminal or a server device) other than the obstacle detection apparatus 2000. The apparatus that generates the position information 50 acquires information (for example, the measurement data) necessary for determining the position of the user 20, and determines the position of the user 20 by using the acquired information, thereby generating the position information 50.

### <Acquisition of Position Information 50: S106>

The acquisition unit 2020 acquires the position information 50 (S106). A method for acquiring the position information 50 is arbitrary. For example, the acquisition unit 2020 acquires the position information 50 by receiving the position information 50 transmitted from an apparatus that has generated the position information 50. In addition, for example, the acquisition unit 2020 may acquire the position information 50 by accessing a storage unit in which the position information 50 is stored.

### <Determination of Detection Range: S108>

The detection range determination unit 2040 determines the detection range by using the three-dimensional map 40 and the position information 50 (S108). For this purpose, first, the detection range determination unit 2040 determines the position of the user 20 on the three-dimensional map 40 (a position on three-dimensional map 40 that corresponds to the position of the user 20 represented by the position information 50). Here, it is assumed that the coordinate system of the three-dimensional map 40 and the coordinate system of the coordinates of the user 20 indicated by the position information 50 are different from each other. In this case, the detection range determination unit 2040 determines the position of the user 20 on the three-dimensional map 40 by converting the coordinates of the user 20 indicated by the position information 50 into coordinates on the coordinate system of the three-dimensional map 40. A relationship between the coordinate system of the three-dimensional map 40 and the coordinate system of the coordinates of the user 20 indicated by the position information 50 is defined in advance.

Here, an existing method can be used as a method for converting coordinates on a certain coordinate system into coordinates on another coordinate system. For example, a transformation matrix for performing coordinate transformation from the coordinate system of the coordinates of the user 20 indicated by the position information 50 to the coordinate system of the three-dimensional map 40 is defined in advance. In this case, the detection range determination unit 2040 calculates the coordinates representing the position of the user 20 on the three-dimensional map 40 by applying the transformation matrix to the coordinates of the user 20 indicated by the position information 50.

On the other hand, it is assumed that the coordinate system of the three-dimensional map 40 and the coordinate system of the coordinates of the user 20 indicated by the position information 50 are the same as each other. In this case, the position of the user 20 on the three-dimensional map 40 is represented by the coordinates of the user 20 indicated by the position information 50. Therefore, the detection range determination unit 2040 can use the position of the user 20 indicated by the position information 50 as it is as the position of the user 20 on the three-dimensional map 40.

After the position of the user 20 on the three-dimensional map 40 is determined, the detection range determination unit 2040 determines the detection range on the three-dimensional map 40 based on the position of the user 20 on the three-dimensional map 40. The detection range is a range around the user 20, and is a range as a detection target for the obstacle region.

There are various methods for determining the detection range. For example, the detection range determination unit 2040 determines, as the detection range, a range having a predetermined shape and a predetermined size and centered on the position of the user 20. The detection range is determined as, for example, a range on a two-dimensional plane in plan view of the three-dimensional map 40. The plan view here may be a view in which the three-dimensional map 40 is viewed from above in a vertical direction, or may be a view in which a floor surface on which the user 20 is located is viewed in a direction opposite to a normal vector thereof. The floor surface here also includes the ground. That is, in a case where the facility 10 is an outdoor facility, the floor surface on which the user 20 is located means the ground on which the user 20 is located.

The shape of the detection range can be any shape such as a circle or a rectangle. The shape of the detection range may be fixed in advance or may be changeable by an input operation. Similarly, the size of the detection range may be fixed in advance or may be changeable by an input operation.

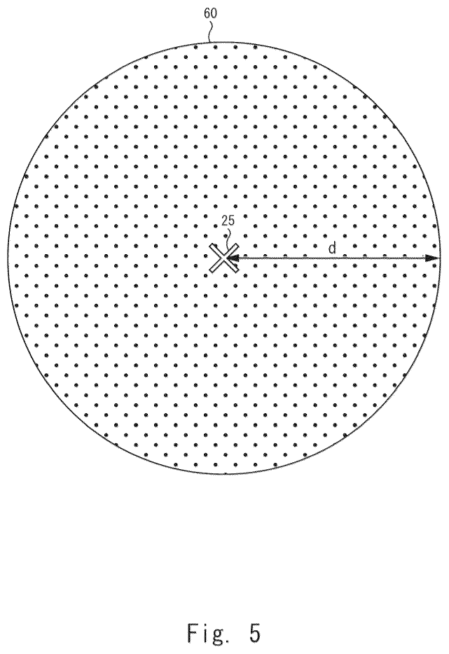

FIG. 5 is a first diagram illustrating the detection range. A detection range 60 is a range of a radius d centered on a position 25 of the user 20 in plan view.

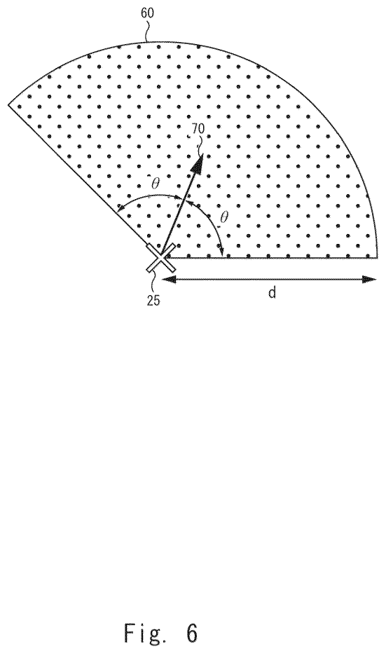

The detection range may be determined based on a direction (a line-of-sight direction or movement direction) of the user 20. For example, the detection range is determined in a range of a predetermined angle with the direction of the user 20 as a reference direction. FIG. 6 is a second diagram illustrating the detection range. In FIG. 6, the direction of the user 20 is indicated by an arrow 70. The detection range 60 is defined as a fan-shaped range having a radius of d and a range of ±θ° with respect to the direction of the user 20 in plan view.

As described above, by narrowing a range in which the obstacle 30 is detected with reference to the direction of the user 20, it is possible to reduce a time and computer resources required for the detection while detecting an object having a high probability of being an obstacle to the movement of the user 20.

Here, various technologies can be used as a technology for detecting the line-of-sight direction or the movement direction of the user 20. For example, the measurement direction of the sensor provided in the user terminal used by the user 20 can be determined, and the measurement direction can be treated as the line-of-sight direction or the movement direction of the user. Here, an existing technology can be used as a technology for determining the measurement direction based on the measurement data obtained from the sensor. In addition, for example, the movement direction of the user 20 may be determined from a temporal change of the position of the user 20 indicated by each of a plurality of pieces of position information 50 acquired so far.

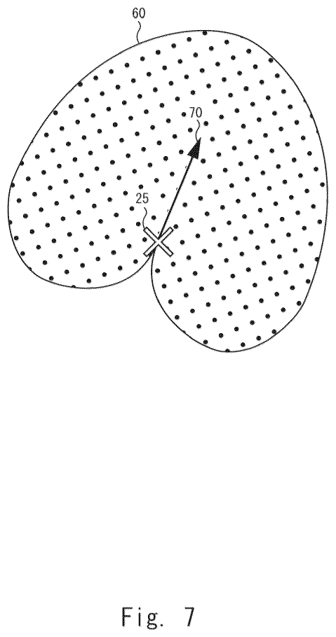

The detection range may be determined in such a way as to be wider in a region that is in a direction closer to the direction of the user 20. FIG. 7 is a third diagram illustrating the detection range. In the example of FIG. 7, a distance from the user 20 to a boundary of the detection range becomes longer in a direction closer to the direction of the user 20. In this way, the detection of the obstacle 30 can be performed in a wider range in a case where the range is a range in a direction in which the user 20 is more likely to move.

The detection range may be determined not only in a horizontal direction but also in the vertical direction. In addition, for example, the detection range determination unit 2040 may determine, as the detection range, a range above, below or both from the position of the user 20 within a predetermined distance from the position of the user 20. The predetermined distance may be the same or different between a range above the position of the user 20 and a range below the position of the user 20. In addition, for example, in a case where there are a plurality of floors in the facility 10, the detection range determination unit 2040 preferably determines a floor on which the user 20 is located and limits the detection range to only that floor.

### <Detection of Obstacle Region: S110>

The detection unit 2060 detects the obstacle region from the detection range 60 (S110). There are various methods for detecting the obstacle region from the detection range 60. For example, one or more obstacle regions are determined in advance for the three-dimensional map 40. In this case, the detection unit 2060 determines whether or not there is an obstacle region included in the detection range 60 among the obstacle regions determined in advance. In a case where there is an obstacle region included in the detection range 60, the detection unit 2060 detects the obstacle region as the obstacle region included in the detection range 60. In a case where there is no obstacle region included in the detection range 60, no obstacle region is detected.

In a case where the obstacle region is determined in advance, the acquisition unit 2020 acquires information defining the obstacle region (hereinafter, referred to as obstacle definition information) together with the three-dimensional map 40. The obstacle definition information is stored in an arbitrary storage unit in a manner that can be acquired by the obstacle detection apparatus 2000. The obstacle definition information may be included in the three-dimensional map 40.

There are various methods for generating the obstacle definition information. For example, the obstacle definition information is manually generated by an administrator of the obstacle detection apparatus 2000. In addition, for example, the obstacle definition information may be automatically generated by a computer. The computer that generates the obstacle definition information may be the obstacle detection apparatus 2000 or may be an apparatus other than the obstacle detection apparatus 2000. Hereinafter, the computer that generates the obstacle definition information is referred to as an obstacle definition information generation apparatus.

In a case where the obstacle definition information is automatically generated, a condition for a region to be treated as the obstacle region (hereinafter, referred to as an obstacle condition) is determined. The obstacle definition information generation apparatus detects a region satisfying the obstacle condition from among regions included in the three-dimensional map 40, and generates the obstacle definition information indicating the region as the obstacle region.

The detection unit 2060 does not have to use the obstacle definition information to detect the obstacle region. In other words, the obstacle region included in the three-dimensional map 40 does not have to be defined in advance. In this case, for example, the detection unit 2060 detects a region satisfying the obstacle condition from the detection range 60 and treats the region as the obstacle region. That is, a region satisfying the obstacle condition among the regions included in the detection range 60 is detected as the obstacle region. Information indicating the obstacle condition is stored in advance in an arbitrary storage unit in a manner that can be acquired by the obstacle detection apparatus 2000.

Hereinafter, in order to make the description easier to understand, it is assumed that the obstacle region satisfying the obstacle condition is detected by the detection unit 2060. Even in a case where the obstacle region satisfying the obstacle condition is detected by the obstacle definition information generation apparatus, the obstacle region can be detected by a similar method.

For example, the obstacle condition is defined as a condition for a surface. In this case, the detection unit 2060 determines whether or not the obstacle condition is satisfied for each surface of the detection range 60 in the three-dimensional map 40. Then, three-dimensional data representing a surface satisfying the obstacle condition or three-dimensional data of an object including that surface is detected as the obstacle region. Hereinafter, a surface subjected to determination of whether or not the obstacle condition is satisfied is referred to as a target surface.

The obstacle condition is set in such a way that a surface desired to be treated as the obstacle 30 satisfies the obstacle condition. For example, the obstacle condition is a condition that “an angle formed by the target surface and a horizontal plane is large (for example, equal to or larger than a threshold)”. The condition is satisfied when the target surface is not a lying surface but a standing surface. The reason why a surface satisfying such a condition is treated as an obstacle is that a probability that the user 20 stumbles is lower for a lying surface, and the probability that the user 20 stumbles is higher for a standing surface.

Whether or not the angle formed by the target surface and the horizontal plane is large can be verified using, for example, a normal vector of the target surface. Specifically, the closer the direction of the normal vector of the target surface is to the horizontal direction, the closer the angle formed by the target surface and the horizontal plane is to 90°. Therefore, for example, an obstacle condition that “an angle formed by a normal direction of the target surface and the horizontal direction is equal to or smaller than a threshold” may be used, the obstacle condition being more specific than the obstacle condition that “an angle formed by the target surface and the horizontal plane is large”.

In addition, for example, the obstacle condition may be determined in such a way that a surface having a relatively small height from the floor surface is detected as the obstacle region. It is considered that an object having a small height from the floor surface is less likely to be included in the field of view of the user 20, and is likely to cause falling. Therefore, for example, a condition that “the height of the target surface from the floor surface is equal to or less than a threshold” is determined as the obstacle condition.

Here, the floor surface means a floor surface on which an object including the target surface is located. In the facility 10, it is possible that a plurality of floors exist or that scaffoldings are provided in various places. In such a case, the “height of the target surface from the floor surface” is the height of the floor or scaffolding on which the object including the target surface is placed from the floor surface.

Therefore, for example, detection unit 2060 first determines a floor surface on which the object including the target surface is located. Then, the detection unit 2060 calculates a value obtained by subtracting a z coordinate of the floor surface from the maximum z coordinate among z coordinates of points included in the target surface, as the height of the target surface from the floor surface. However, a method for calculating the height of the target surface from the floor surface is not limited thereto.

As the obstacle condition, for example, a condition of “being located at a place where the height from the floor surface is equal to or less than a threshold” can be used. For example, it is considered that a probability that the user collides with an object installed at a position higher than the floor surface by 2 m or more is low. Therefore, the target surface present at a high position where the user 20 is unlikely to collide is not treated as the obstacle region.

The obstacle condition may include a plurality of conditions. For example, a condition that “1) the angle formed by the normal direction of the target surface and the horizontal direction is equal to or smaller than a threshold, and 2) the height of the target surface from the floor surface is equal to or less than a threshold” may be used as the obstacle condition. In this case, the target surface that is standing and has a small height is determined as the target surface satisfying the obstacle condition.

### <<Target Surface Detection Method>>

The detection unit 2060 detects one or more target surfaces in the detection range 60 on the three-dimensional map 40, and determines whether or not each target surface satisfies the obstacle condition. For this purpose, the detection unit 2060 detects the target surface. Hereinafter, a target surface detection method will be described.

For example, the detection unit 2060 clusters each point data included in the detection range 60 among pieces of point data shown on the three-dimensional map 40 into sets of point data representing the same plane. Then, the detection unit 2060 treats a surface represented by each cluster as the target surface. That is, a plurality of pieces of point data included in one cluster is treated as a group of point data constituting one target surface.

There are various methods for clustering point data for each same surface. For example, the detection unit 2060 calculates a normal vector of each point data included in the detection range 60. Here, the normal vector of the point data can be calculated as, for example, a normal vector of a triangular surface including the point data and other two pieces of point data close to the point data. In a case where the three-dimensional map 40 is mesh data, the normal vector of the point data can be calculated as a normal vector of any one surface including the point data.

The detection unit 2060 clusters point data based on a direction of a normal vector. Specifically, in a case where a difference between a direction of a normal vector of a certain piece of point data and a direction of a normal vector of another piece of point data close to the point data (for example, a distance therebetween is equal to or less than a threshold) is small (for example, the difference is equal to or less than a threshold), the detection unit 2060 puts these pieces of point data into the same cluster. With this processing, a plurality of adjacent small surfaces having close directions can be regarded as one large surface.

Here, in the three-dimensional map 40, there may be an object having a curved surface, such as a pipe or a tank. Therefore, for example, the detection unit 2060 may detect a cylindrical region by performing cylindrical fitting, and treat a side surface of the cylindrical region as the target surface. Here, the cylindrical fitting can be implemented using an algorithm such as RANSAC. Here, as in a case where the side surface of the cylindrical region is the target surface, the target surface may be a curved surface. In this case, in order to determine whether or not the obstacle condition that “the angle between the target surface and the horizontal plane is large” is satisfied, a normal line in a direction closest to the horizontal direction among normal lines of the target surface is used. That is, when an angle formed by the direction of the normal line in the direction closest to the horizontal direction and the horizontal direction is equal to or smaller than a threshold, it is determined that the obstacle condition (in other words, the condition that “the angle formed by the normal line of the target surface and the horizontal plane is equal to or smaller than the threshold”) is satisfied.

In a case of performing the cylindrical fitting, the detection unit 2060 detects a region that is highly likely to have a cylindrical shape from the three-dimensional map 40, and performs the cylindrical fitting on the region. This can be achieved, for example, by utilizing semantic segmentation. Specifically, the detection unit 2060 performs the semantic segmentation on point data included in the detection range 60 by clustering these pieces of point data for each point data representing the same object. As a result, the pieces of point data are divided into clusters for each point data representing the same object. In addition, the type (a wall, a tank, a pipe, an iron structure, or the like) of the object represented by each cluster is determined.

Furthermore, the detection unit 2060 performs the cylindrical fitting on point data included in each cluster of the type (a tank, a pipe, or the like) to be subjected to the cylindrical fitting, thereby determining the target surface corresponding to the cluster. A type to be subjected to the cylindrical fitting is determined in advance.

The detection unit 2060 may use both a method of clustering the point data based on the normal vector and a method using the cylindrical fitting. In this case, for example, the detection unit 2060 first determines a region to be subjected to the cylindrical fitting, and performs the cylindrical fitting on the region to detect the side surface of the cylindrical region as the target surface. Thereafter, the detection unit 2060 detects the remaining target surface by performing clustering using the normal vector on each point data not included in the cylindrical region among the pieces of point data included in the detection range 60.

In addition, for example, the detection unit 2060 may divide the pieces of point data into clusters for each same object by the semantic segmentation, and then detect the target surface for each object. In this case, first, the detection unit 2060 applies the semantic segmentation to the pieces of point data included in the detection range 60 to divide the pieces of point data into clusters for each point data representing the same object. Next, the detection unit 2060 performs detection of the target surface using the cylindrical fitting for a cluster of an object of the type to be subjected to the cylindrical fitting. Furthermore, for clusters of other types of objects, the detection unit 2060 performs clustering using the normal vector described above on a plurality of pieces of point data included in the same cluster. As a result, a plurality of target surfaces are detected from the cluster of the same object.

In addition, for example, in a case where the three-dimensional map 40 includes point cloud data, the detection unit 2060 may detect the target surface by converting the point cloud data into mesh data. As a result, data representing a plurality of surfaces is obtained from the point cloud data. Therefore, for example, the detection unit 2060 treats each surface obtained by meshing as the target surface. Therefore, for example, the detection unit 2060 treats each surface obtained by meshing as target data. However, the detection unit 2060 may downsample the point cloud data and then convert the downsampled point cloud data into mesh data in order to treat a surface having a certain size as the target surface.

### <<Detection of Obstacle Detected in Real Time>>

In a case where three-dimensional data of an object around the user 20 is obtained by measurement performed in real time, the obstacle region may be detected from the three-dimensional data that is obtained as mentioned above. For example, the detection unit 2060 obtains a difference between three-dimensional data obtained by measurement performed in real time and the three-dimensional map 40, thereby determining three-dimensional data representing an object not shown on the three-dimensional map 40. As described above, among pieces of three-dimensional data obtained by real-time measurement, three-dimensional data representing an object not shown on the three-dimensional map 40 is referred to as temporary three-dimensional data. The temporary three-dimensional data is, for example, three-dimensional data representing an object such as equipment or a cable temporarily placed in the facility 10.

The detection unit 2060 detects, from the temporary three-dimensional data, a surface whose position on the three-dimensional map 40 is within the detection range 60 and which satisfies the obstacle condition. Then, the surface detected in this manner or a region representing an object including the surface is also treated as the obstacle region. However, it is preferable that the obstacle region detected from the three-dimensional map 40 and the obstacle region detected from the temporary three-dimensional data can be distinguished from each other. For example, as described below, in a case where information regarding the obstacle region is output, the information indicates from which of the three-dimensional map 40 and the temporary three-dimensional data each obstacle region has been detected.

### <Output of Detection Result>

When the obstacle region is detected, the obstacle detection apparatus 2000 preferably outputs information regarding the detected obstacle region. The information output here is referred to as output information. Hereinafter, a functional configuration unit that outputs the output information is referred to as an output unit.

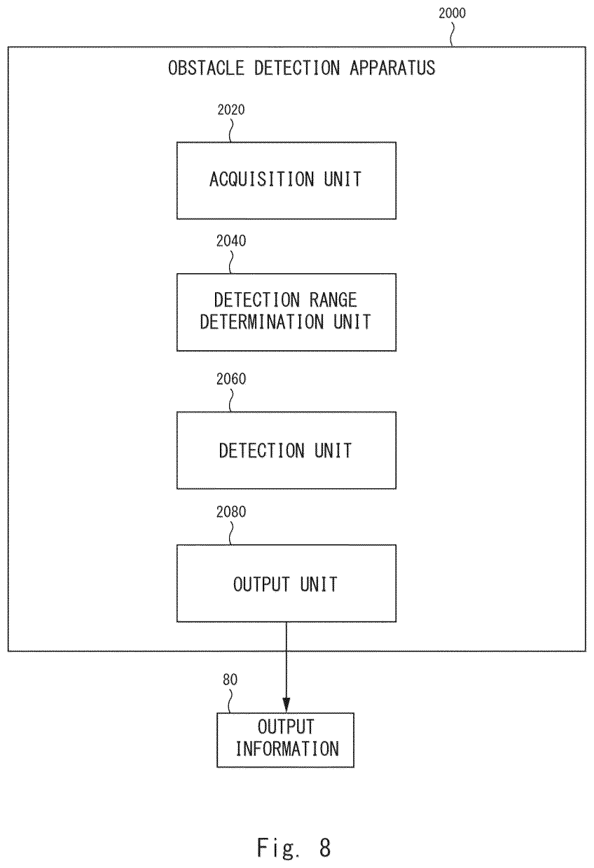

FIG. 8 is a block diagram illustrating a functional configuration of the obstacle detection apparatus 2000 including the output unit. An output unit 2080 outputs output information 80. An output destination of the output information 80 is, for example, the user terminal of the user 20. By outputting the output information 80 to the user terminal, the user 20 can easily grasp the presence of the obstacle 30. Therefore, the safety when using the facility 10 is improved for the user 20 who moves in the facility 10. The output destination of the output information 80 is arbitrary and is not limited to the user terminal.

The output information 80 indicates various information. For example, the output information 80 indicates the type (a step, a device, a desk, a cable, or the like), size, position, or the like of the obstacle 30 indicated by the obstacle region. In addition, as described above, in a case where the obstacle region is detected also from the temporary three-dimensional data, the output information 80 may indicate, for each obstacle region, from which of the three-dimensional map 40 and the temporary three-dimensional data the obstacle region has been detected.

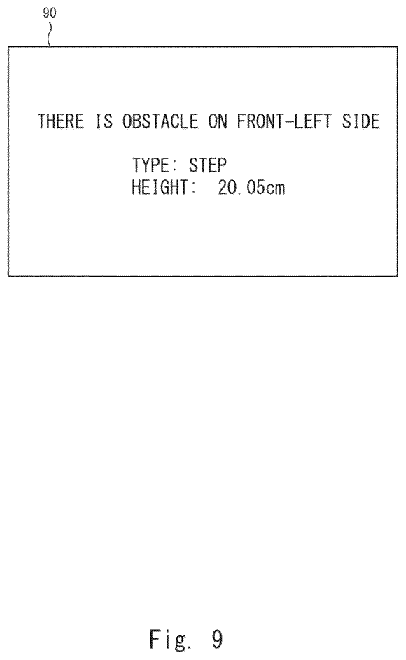

The output information 80 represents, for example, a warning for notifying the user 20 of the presence of the obstacle 30. In this case, the output information 80 preferably includes a message indicating the warning. FIG. 9 is a first diagram illustrating the output information 80. FIG. 9 illustrates a message 90 indicating a content of the output information 80. The message 90 indicates the position (diagonally front-left side) of the obstacle, the size (a height of about 20 cm) of the obstacle, and the type (step) of the obstacle. The message 90 is displayed, for example, on a display device of the user terminal possessed by the user 20.

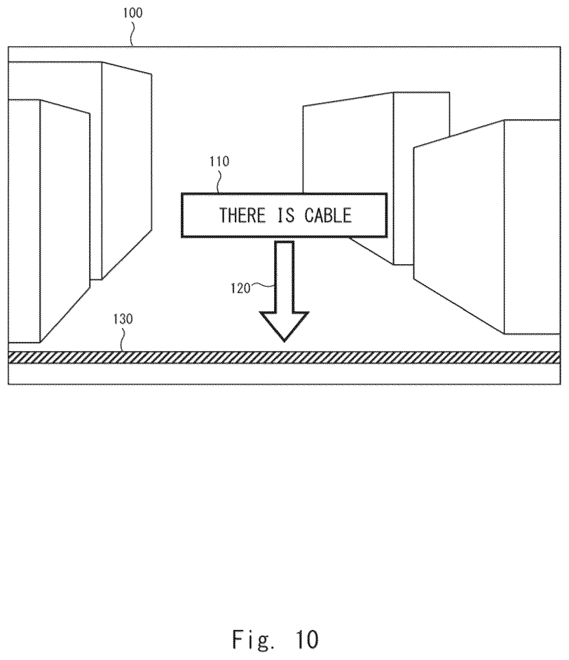

The output information 80 may further include a three-dimensional map of the periphery of the obstacle region. FIG. 10 is a second diagram illustrating the output information 80. FIG. 10 illustrates a screen 100 on which the content of the output information 80 is displayed. On the screen 100, a portion of the three-dimensional map 40 that is included in the field of view of the user 20 is displayed. In addition, an obstacle region 130 is highlighted on the screen 100. Specifically, the obstacle region 130 is hatched. Further, a message 110 for notifying that a cable is present as the obstacle 30 and an arrow 120 indicating a direction in which the obstacle 30 is located are displayed on the screen 100. The range of the three-dimensional map 40 displayed on the screen 100 is preferably changed in accordance with a change in the field of view of the user 20 (a change in position or direction of the user 20).

There are various methods for determining a portion of the three-dimensional map 40 that is included in the field of view of the user 20. For example, the output unit 2080 treats, as the portion included in the field of view of the user 20, a portion of the three-dimensional map 40 that is included in a predetermined range representing the field of view when the movement direction of the user 20 is viewed from the position of the user 20. In addition, for example, in a case where the user 20 uses a camera provided in the user terminal (hereinafter, referred to as a user camera), the output unit 2080 may treat, as the portion of the three-dimensional map 40 that is included in the field of view of the user 20, a capturing range of the user camera or a portion of the three-dimensional map 40 that is included in a predetermined range.

Here, it is assumed that a scene in a field-of-view direction of the user 20 is captured using the user camera. In this case, a video obtained from the user camera may be displayed on the screen 100 instead of the three-dimensional map 40. In this case, the output unit 2080 superimposes the various indicators illustrated in FIG. 10 on the video obtained from the user camera. Specifically, the output unit 2080 determines a region corresponding to the obstacle region detected from the detection range from the video, and highlights the region. In addition, the output unit 2080 superimposes the message 110 and the arrow 120 indicating the direction of the region corresponding to the obstacle region on the video of the user camera.

In addition, it is assumed that the user 20 wears a glasses-type device, and the glasses-type device is configured to display arbitrary information on a transmission type lens functioning as a display device so that the information can be superimposed on an actual scene seen through the lens. In this case, the output unit 2080 superimposes information regarding the obstacle 30 on a surrounding scene viewed by the user 20 through the glasses-type device. Specifically, the output unit 2080 determines a region corresponding to the obstacle region in a region of the lens, and displays an image (for example, an image of a specific color covering the obstacle region) indicating the obstacle region for the region. Further, the output unit 2080 displays the message 110 and the arrow 120 on the lens.

The output information 80 is not limited to visual information. For example, the output information 80 may be auditory information. That is, the output unit 2080 may output a message indicating a warning or a message indicating the position of an obstacle as a voice message. In this case, the user 20 can grasp the obstacle by listening to the voice message output from a speaker provided in the user terminal or the facility 10.

There are various ways of outputting the output information 80. For example, the output unit 2080 transmits the output information 80 to the user terminal. In addition, for example, the output unit 2080 may output the output information 80 to a storage unit accessible by the user terminal. In this case, the user terminal acquires the output information 80 by accessing the storage unit. In addition, for example, in a case where the output information 80 is a voice message, the output information 80 may be output to the speaker provided in the facility 10 to cause the speaker to output the voice message. Here, in a case where a plurality of speakers are provided in the facility 10, for example, the output unit 2080 preferably determines a speaker closest to the position of the user 20 and outputs the output information 80 to the speaker.

Although the present invention has been described above with reference to the example embodiments, the present invention is not limited to the above-described example embodiments. Various changes that can be understood by those skilled in the art can be made to the configurations and details of the present invention within the scope of the present invention.

In the above-described example, the program includes a group of commands (or software codes) for causing the computer to execute one or more functions described in the example embodiments, when read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, the transitory computer-readable medium or the communication medium includes electrical, optical, acoustic, or other forms of propagated signals.

Some or all of the above-described example embodiments can be described as in the following supplementary notes, but are not limited to the following supplementary notes.

### (Supplementary Note 1)

An obstacle detection apparatus including:
an acquisition unit configured to acquire a three-dimensional map representing a three-dimensional position of each of a plurality of points of a facility and position information representing a position of a user;
a detection range determination unit configured to determine a detection range as a detection target for an obstacle region from a region around the position of the user on the three-dimensional map by using the three-dimensional map and the position information; and
a detection unit configured to detect the obstacle region from the detection range.

### (Supplementary Note 2)

The obstacle detection apparatus according to Supplementary Note 1, in which
the detection range determination unit
determines the position of the user on the three-dimensional map, and
determines, as the detection range, a range having a predetermined size and including the determined position.

### (Supplementary Note 3)

The obstacle detection apparatus according to Supplementary Note 1, in which
the detection range determination unit
determines the position of the user and a movement direction or line-of-sight direction of the user on the three-dimensional map, and
determines, as the detection range, a range of a predetermined angle including the movement direction or line-of-sight direction of the user.

### (Supplementary Note 4)

The obstacle detection apparatus according to Supplementary Note 1, in which
the detection range determination unit
determines the position of the user and a movement direction or line-of-sight direction of the user on the three-dimensional map, and
determines the detection range in such a way that a size in the movement direction or line-of-sight direction of the user is larger than sizes in other directions.

### (Supplementary Note 5)

The obstacle detection apparatus according to any one of Supplementary Notes 1 to 4, in which the detection unit detects, from target surfaces that are surfaces included in the detection range on the three-dimensional map, as the obstacle region, a region representing a target surface that satisfies an obstacle condition that is a condition for being treated as an obstacle or a region representing an object including the target surface.

### (Supplementary Note 6)

The obstacle detection apparatus according to Supplementary Note 5, in which the obstacle condition includes a condition that an angle formed by the target surface and a horizontal direction is equal to or larger than a first threshold.

### (Supplementary Note 7)

The obstacle detection apparatus according to Supplementary Note 5 or 6, in which the obstacle condition includes a condition that a height of the target surface from a floor surface is equal to or less than a second threshold.

### (Supplementary Note 8)

The obstacle detection apparatus according to any one of Supplementary Notes 1 to 7, further including an output unit configured to output output information indicating information regarding the detected obstacle region.

### (Supplementary Note 9)

The obstacle detection apparatus according to Supplementary Note 8, in which the output information includes a screen that includes: an indicator that highlights the obstacle region: an indicator that indicates a position or a direction of the obstacle region; an indicator that indicates a type of an obstacle represented by the obstacle region: or two or more of the indicators.

### (Supplementary Note 10)

An obstacle detection method executed by a computer, the obstacle detection method including:
an acquisition step of acquiring a three-dimensional map representing a three-dimensional position of each of a plurality of points of a facility and position information representing a position of a user;
a detection range determination step of determining a detection range as a detection target for an obstacle region from a region around the position of the user on the three-dimensional map by using the three-dimensional map and the position information; and
a detection step of detecting the obstacle region from the detection range.

### (Supplementary Note 11)

The obstacle detection method according to Supplementary Note 10, in which
in the detection range determination step,
determining the position of the user on the three-dimensional map, and
determining, as the detection range, a range having a predetermined size and including the determined position.

### (Supplementary Note 12)

The obstacle detection method according to Supplementary Note 10, in which
in the detection range determination step,
determining the position of the user and a movement direction or line-of-sight direction of the user on the three-dimensional map, and
determining, as the detection range, a range of a predetermined angle including the movement direction or line-of-sight direction of the user.

### (Supplementary Note 13)

The obstacle detection method according to Supplementary Note 10, in which
in the detection range determination step,
determining the position of the user and a movement direction or line-of-sight direction of the user on the three-dimensional map, and
determining the detection range in such a way that a size in the movement direction or line-of-sight direction of the user is larger than sizes in other directions.

### (Supplementary Note 14)

The obstacle detection method according to any one of Supplementary Notes 10 to 13, in which in the detection step, detecting, from target surfaces that are surfaces included in the detection range on the three-dimensional map, as the obstacle region, a region representing a target surface that satisfies an obstacle condition that is a condition for being treated as an obstacle or a region representing an object including the target surface.

### (Supplementary Note 15)

The obstacle detection method according to Supplementary Note 14, in which the obstacle condition includes a condition that an angle formed by the target surface and a horizontal direction is equal to or larger than a first threshold.

### (Supplementary Note 16)

The obstacle detection method according to Supplementary Note 14 or 15, in which the obstacle condition includes a condition that a height of the target surface from a floor surface is equal to or less than a second threshold.

### (Supplementary Note 17)

The obstacle detection method according to any one of Supplementary Notes 10 to 16, further including an output step of outputting output information indicating information regarding the detected obstacle region.

### (Supplementary Note 18)

The obstacle detection method according to Supplementary Note 17, in which the output information includes a screen that includes: an indicator that highlights the obstacle region: an indicator that indicates a position or a direction of the obstacle region: an indicator that indicates a type of an obstacle represented by the obstacle region: or two or more of the indicators.

### (Supplementary Note 19)

A non-transitory computer-readable medium storing a program for causing a computer to execute:
an acquisition step of acquiring a three-dimensional map representing a three-dimensional position of each of a plurality of points of a facility and position information representing a position of a user;
a detection range determination step of determining a detection range as a detection target for an obstacle region from a region around the position of the user on the three-dimensional map by using the three-dimensional map and the position information; and
a detection step of detecting the obstacle region from the detection range.

### (Supplementary Note 20)

The computer-readable medium according to Supplementary Note 19, in which
in the detection range determination step,
determining the position of the user on the three-dimensional map, and
determining, as the detection range, a range having a predetermined size and including the determined position.

### (Supplementary Note 21)

The computer-readable medium according to Supplementary Note 19, in which
in the detection range determination step,
determining the position of the user and a movement direction or line-of-sight direction of the user on the three-dimensional map, and
determining, as the detection range, a range of a predetermined angle including the movement direction or line-of-sight direction of the user.

### (Supplementary Note 22)

The computer-readable medium according to Supplementary Note 19, in which
in the detection range determination step,
determining the position of the user and a movement direction or line-of-sight direction of the user on the three-dimensional map, and
determining the detection range in such a way that a size in the movement direction or line-of-sight direction of the user is larger than sizes in other directions.

### (Supplementary Note 23)

The computer-readable medium according to any one of Supplementary Notes 19 to 22, in which in the detection step, detecting, from target surfaces that are surfaces included in the detection range on the three-dimensional map, as the obstacle region, a region representing a target surface that satisfies an obstacle condition that is a condition for being treated as an obstacle or a region representing an object including the target surface.

### (Supplementary Note 24)

The computer-readable medium according to Supplementary Note 23, in which the obstacle condition includes a condition that an angle formed by the target surface and a horizontal direction is equal to or larger than a first threshold.

### (Supplementary Note 25)

The computer-readable medium according to Supplementary Note 23 or 24, in which the obstacle condition includes a condition that a height of the target surface from a floor surface is equal to or less than a second threshold.

### (Supplementary Note 26)

The computer-readable medium according to any one of Supplementary Notes 19 to 25, further including an output step of outputting output information indicating information regarding the detected obstacle region.

### (Supplementary Note 27)

The computer-readable medium according to Supplementary Note 26, in which the output information includes a screen that includes: an indicator that highlights the obstacle region; an indicator that indicates a position or a direction of the obstacle region; an indicator that indicates a type of an obstacle represented by the obstacle region; or two or more of the indicators.

### REFERENCE SIGNS LIST

10 FACILITY
20 USER
25 POSITION
30 OBSTACLE
40 THREE-DIMENSIONAL MAP
50 POSITION INFORMATION
60 DETECTION RANGE
70 ARROW
80 OUTPUT INFORMATION
90 MESSAGE
100 SCREEN
110 MESSAGE
120 ARROW
130 OBSTACLE REGION
500 COMPUTER
502 BUS
504 PROCESSOR
506 MEMORY
508 STORAGE DEVICE
510 INPUT/OUTPUT INTERFACE
512 NETWORK INTERFACE
2000 OBSTACLE DETECTION APPARATUS
2020 ACQUISITION UNIT
2040 DETECTION RANGE DETERMINATION UNIT
2060 DETECTION UNIT
2080 OUTPUT UNIT

What is claimed is:

1. An obstacle detection apparatus comprising:
at least one memory that is configured to store instructions; and
at least one processor that is configured execute the instructions to:
acquire a three-dimensional map representing a three-dimensional position of each of a plurality of points of a facility and position information representing a position of a user;
determine a detection range as a detection target for an obstacle region from a region around the position of the user on the three-dimensional map by using the three-dimensional map and the position information; and
detect the obstacle region from the detection range.

2. The obstacle detection apparatus according to claim 1, wherein
the determination of the detection range includes:
determining the position of the user on the three-dimensional map, and
determining, as the detection range, a range having a predetermined size and including the determined position.

3. The obstacle detection apparatus according to claim 1, wherein
the determination of the detection range includes:
determining the position of the user and a movement direction or line-of-sight direction of the user on the three-dimensional map, and
determining, as the detection range, a range of a predetermined angle including the movement direction or line-of-sight direction of the user.

4. The obstacle detection apparatus according to claim 1, wherein
the determination of the detection range includes:
determining the position of the user and a movement direction or line-of-sight direction of the user on the three-dimensional map, and
determining the detection range in such a way that a size in the movement direction or line-of-sight direction of the user is larger than sizes in other directions.

5. The obstacle detection apparatus according to claim 1, wherein the detection of the obstacle region includes detecting, from target surfaces that are surfaces included in the detection range on the three-dimensional map, as the obstacle region, a region representing the target surface that satisfies an obstacle condition that is a condition for being treated as an obstacle or a region representing an object including the target surface.

6. The obstacle detection apparatus according to claim 5, wherein the obstacle condition includes a condition that an angle formed by the target surface and a horizontal direction is equal to or larger than a first threshold.

7. The obstacle detection apparatus according to claim 5, wherein the obstacle condition includes a condition that a height of the target surface from a floor surface is equal to or less than a second threshold.

8. The obstacle detection apparatus according to claim 1, further comprising an output unit configured to output output information indicating information regarding the detected obstacle region.

9. The obstacle detection apparatus according to claim 8, wherein the output information includes a screen that includes: an indicator that highlights the obstacle region; an indicator that indicates a position or a direction of the obstacle region; an indicator that indicates a type of an obstacle represented by the obstacle region; or two or more of the indicators.

10. An obstacle detection method executed by a computer, the obstacle detection method comprising:
acquiring a three-dimensional map representing a three-dimensional position of each of a plurality of points of a facility and position information representing a position of a user;
determining a detection range as a detection target for an obstacle region from a region around the position of the user on the three-dimensional map by using the three-dimensional map and the position information; and
detecting the obstacle region from the detection range.

11. The obstacle detection method according to claim 10, wherein
the determination of the detection range includes:
determining the position of the user on the three-dimensional map, and
determining, as the detection range, a range having a predetermined size and including the determined position.

12. The obstacle detection method according to claim 10, wherein
the determination of the detection range includes:
determining the position of the user and a movement direction or line-of-sight direction of the user on the three-dimensional map, and
determining, as the detection range, a range of a predetermined angle including the movement direction or line-of-sight direction of the user.

13. The obstacle detection method according to claim 10, wherein
the determination of the detection range includes:
determining the position of the user and a movement direction or line-of-sight direction of the user on the three-dimensional map, and
determining the detection range in such a way that a size in the movement direction or line-of-sight direction of the user is larger than sizes in other directions.

14. The obstacle detection method according to claim 10, wherein the detection of the obstacle region includes detecting, from target surfaces that are surfaces included in the detection range on the three-dimensional map, as the obstacle region, a region representing the target surface that satisfies an obstacle condition that is a condition for being treated as an obstacle or a region representing an object including the target surface.

15. The obstacle detection method according to claim 14, wherein the obstacle condition includes a condition that an angle formed by the target surface and a horizontal direction is equal to or larger than a first threshold.

16-18. (canceled)

19. A non-transitory computer-readable medium storing a program for causing a computer to execute:
acquiring a three-dimensional map representing a three-dimensional position of each of a plurality of points of a facility and position information representing a position of a user;
determining a detection range as a detection target for an obstacle region from a region around the position of the user on the three-dimensional map by using the three-dimensional map and the position information; and
detecting the obstacle region from the detection range.

20. The computer-readable medium according to claim 19, wherein
the determination of the detection range includes:
determining the position of the user on the three-dimensional map, and
determining, as the detection range, a range having a predetermined size and including the determined position.

21. The computer-readable medium according to claim 19, wherein
the determination of the detection range includes:
determining the position of the user and a movement direction or line-of-sight direction of the user on the three-dimensional map, and
determining, as the detection range, a range of a predetermined angle including the movement direction or line-of-sight direction of the user.

22. The computer-readable medium according to claim 19, wherein
the determination of the detection range includes:
determining the position of the user and a movement direction or line-of-sight direction of the user on the three-dimensional map, and
determining the detection range in such a way that a size in the movement direction or line-of-sight direction of the user is larger than sizes in other directions.

23. The computer-readable medium according to claim 19, wherein the detection of the obstacle region includes detecting, from target surfaces that are surfaces included in the detection range on the three-dimensional map, as the obstacle region, a region representing the target surface that satisfies an obstacle condition that is a condition for being treated as an obstacle or a region representing an object including the target surface.

24-27. (canceled)
